(19) United States
(12) Patent Application Publication
(10) Pub. No.: US 2021/0256489 A1
(43) Pub. Date: Aug. 19, 2021

(54) SYSTEM FOR AUTOMATED RESOURCE TRANSFERS BASED ON PREDICTIVE ELECTRONIC DATA ANALYSIS

(71) Applicant: Bank of America Corporation, Charlotte, NC (US)

(72) Inventors: Malathi Jivan, San Jose, CA (US); Poppy Marie Kimball, Redwood City, CA (US); Thomas Elliott, Redwood City, CA (US); Audrey L. Longfellow, Oak Hill, VA (US); Heather Roseann Dolan, Sarasota, FL (US); Christina Ann Lillie, Ann Arbor, MI (US); Justin Riley duPont, Charlotte, NC (US)

(73) Assignee: Bank of America Corporation, Charlotte, NC (US)

(21) Appl. No.: 16/794,457

(22) Filed: Feb. 19, 2020

(51) Int. Cl. G06Q 20/10; G06Q 40/02; G06Q 20/42

(52) U.S. Cl. CPC G06Q 20/102; G06Q 20/42; G06Q 40/02

(57) ABSTRACT

A system for automated resource transfers based on predictive electronic data analysis is provided. In particular, the system may continuously track data (e.g., as historical data) that may be sent between two entities, where the data may include resource transfer data. Based on the parameters of the resource transfer data, the system may identify a pattern within the historical data in order to set up a recurring resource transfer based on the identified pattern. In this way, the system may increase the efficiency of resource transfers executed across entities.

### FIELD OF THE INVENTION

The present disclosure embraces a system for automated resource transfers based on predictive electronic data analysis.

### BACKGROUND

There is a need for a more effective way to execute resource transfers automatically.

### BRIEF SUMMARY

The following presents a simplified summary of one or more embodiments of the invention in order to provide a basic understanding of such embodiments. This summary is not an extensive overview of all contemplated embodiments, and is intended to neither identify key or critical elements of all embodiments, nor delineate the scope of any or all embodiments. Its sole purpose is to present some concepts of one or more embodiments in a simplified form as a prelude to the more detailed description that is presented later.

The present disclosure is directed to a system for automated resource transfers based on predictive electronic data analysis. In particular, the system may continuously track data (e.g., as historical data) that may be sent between two entities, where the data may include resource transfer data. Based on the parameters of the resource transfer data, the system may identify a pattern within the historical data in order to set up a recurring resource transfer based on the identified pattern. In this way, the system may increase the efficiency of resource transfers executed across entities.

Accordingly, embodiments of the present disclosure provide a system for automated resource transfers based on predictive electronic data analysis. The system may comprise a memory device with computer-readable program code stored thereon; a communication device; and a processing device operatively coupled to the memory device and the communication device. The processing device may be configured to execute the computer-readable program code to continuously monitor resource transfer data associated with a first entity; detect, from the resource transfer data, a pattern of resource transfer requests from a second entity to the first entity; based on the pattern of resource transfer requests, generate a recommendation for a recurring resource transfer from the first entity to the second entity; present the recommendation on a graphical interface of a user computing system; receive an acceptance of the recurring resource transfer from the user computing system; and implement the recurring resource transfer based on the resource transfer data.

In some embodiments, implementing the recurring resource transfer comprises detecting one or more resource transfer parameters from the resource transfer data; and scheduling an automatic recurring resource transfer based on the resource transfer parameters.

In some embodiments, the resource transfer parameters comprises at least one of a resource transfer amount, a resource transfer date, and a resource transfer frequency.

In some embodiments, the recurring resource transfer is executed a predetermined number of times.

In some embodiments, the recurring resource transfer is executed indefinitely at a predetermined frequency.

In some embodiments, the computer-readable program code further causes the processing device to generate a prioritization scheme for one or more recurring resource transfers.

In some embodiments, the computer-readable program code further causes the processing device to transmit an alert to the user computing system, wherein the alert comprises information regarding a resource transfer issue.

Embodiments of the present disclosure also provide a computer program product for automated resource transfers based on predictive electronic data analysis. The computer program product may comprise at least one non-transitory computer readable medium having computer-readable program code portions embodied therein, the computer-readable program code portions comprising executable code portions for continuously monitoring resource transfer data associated with a first entity; detecting, from the resource transfer data, a pattern of resource transfer requests from a second entity to the first entity; based on the pattern of resource transfer requests, generating a recommendation for a recurring resource transfer from the first entity to the second entity; presenting the recommendation on a graphical interface of a user computing system; receiving an acceptance of the recurring resource transfer from the user computing system; and implementing the recurring resource transfer based on the resource transfer data.

In some embodiments, implementing the recurring resource transfer comprises detecting one or more resource transfer parameters from the resource transfer data; and scheduling an automatic recurring resource transfer based on the resource transfer parameters.

In some embodiments, the resource transfer parameters comprises at least one of a resource transfer amount, a resource transfer date, and a resource transfer frequency.

In some embodiments, the recurring resource transfer is executed a predetermined number of times.

In some embodiments, the recurring resource transfer is executed indefinitely at a predetermined frequency.

In some embodiments, the computer-readable program code portions further comprise executable portions for generating a prioritization scheme for one or more recurring resource transfers.

Embodiments of the present disclosure also provide a computer-implemented method for automated resource transfers based on predictive electronic data analysis. The method may comprise continuously monitoring resource transfer data associated with a first entity; detecting, from the resource transfer data, a pattern of resource transfer requests from a second entity to the first entity; based on the pattern of resource transfer requests, generating a recommendation for a recurring resource transfer from the first entity to the second entity; presenting the recommendation on a graphical interface of a user computing system; receiving an acceptance of the recurring resource transfer from the user computing system; and implementing the recurring resource transfer based on the resource transfer data.

In some embodiments, implementing the recurring resource transfer comprises detecting one or more resource transfer parameters from the resource transfer data; and scheduling an automatic recurring resource transfer based on the resource transfer parameters.

In some embodiments, the resource transfer parameters comprises at least one of a resource transfer amount, a resource transfer date, and a resource transfer frequency.

In some embodiments, the recurring resource transfer is executed a predetermined number of times.

In some embodiments, the recurring resource transfer is executed indefinitely at a predetermined frequency.

In some embodiments, the method further comprises generating a prioritization scheme for one or more recurring resource transfers.

In some embodiments, the method further comprises transmitting an alert to the user computing system, wherein the alert comprises information regarding a resource transfer issue.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made to the accompanying drawings, wherein:

FIG. 1 illustrates an operating environment for the predictive resource transfer system, in accordance with one embodiment of the present disclosure; and

FIG. 2 illustrates a process flow for the predictive resource transfer system, in accordance with one embodiment of the present disclosure.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to elements throughout. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein.

“Entity” as used herein may refer to an individual or an organization that owns and/or operates an online system of networked computing devices, systems, and/or peripheral devices on which the system described herein is implemented. The entity may be a business organization, a non-profit organization, a government organization, and the like, which may routinely use various types of applications within its enterprise environment to accomplish its organizational objectives.

“Entity system” as used herein may refer to the computing systems, devices, software, applications, communications hardware, and/or other resources used by the entity to perform the functions as described herein. Accordingly, the entity system may comprise desktop computers, laptop computers, servers, Internet-of-Things (“IoT”) devices, networked terminals, mobile smartphones, smart devices (e.g., smart watches), network connections, and/or other types of computing systems or devices and/or peripherals along with their associated applications.

“Computing system” or “computing device” as used herein may refer to a networked computing device within the entity system. The computing system may include a processor, a non-transitory storage medium, a communications device, and a display. The computing system may be configured to support user logins and inputs from any combination of similar or disparate devices. Accordingly, the computing system may be a portable electronic device such as a smartphone, tablet, single board computer, smart device, or laptop. In other embodiments, the computing system may be a stationary unit such as a personal desktop computer, networked terminal, IoT device, or the like.

“User” as used herein may refer to an individual who may interact with the entity system to access the functions therein. Accordingly, the user may be an agent, employee, associate, contractor, or other authorized party who may access, use, administrate, maintain, and/or manage the computing systems within the entity system. In other embodiments, the user may be a client or customer of the entity, or a third party who is not related to the entity. In yet other embodiments, the user may be an entity or organization.

Accordingly, the term “user device” or “mobile device” may refer to mobile phones, personal computing devices, tablet computers, wearable devices, and/or any stationary or portable electronic device capable of receiving and/or storing data therein.

“Resource” as used herein may refer to an object under the ownership of a user which is stored or maintained by the entity on the user's behalf. The resource may be intangible or tangible objects such as data files, documents, funds, and the like. Typically, an account associated with the user contains records of the resources owned by the user. Accordingly, account data may be stored in an account database within the entity's systems.

The system as described herein may use historical resource transfer data to automate resource transfer processes and/or set up recurring resource transfers based on predictive analysis of the historical data. In this regard, the system may continuously collect resource transfer data (e.g., resource amount, transfer destination, metadata, and the like) associated with one or more entities over time. Based on the collected resource transfer data, the system may detect one or more recurring resource transfer patterns. For example, a first entity may generate resource transfer requests to be completed by a second entity on a regular, periodic basis. Based on detecting the pattern, the system may generate one or more recommendations regarding future resource transfers between the first entity and the second entity. In this regard, the system may generate the recommendation based on the parameters of the resource transfer data. Once the first entity and/or the second entity has accepted the one or more recommendations, the system may implement the recommended resource transfer settings such that subsequent resource transfers are automatically executed as defined in the settings.

In an exemplary embodiment, a first entity (e.g., a business organization) may be in a business relationship with a second entity. In this regard, the first entity may generate and send multiple resource transfer requests (e.g., invoices) to the second entity over a period of time. The system may track the interactions (e.g., resource transfers, resource transfer requests) between the two entities, as well as the account information of the first entity and/or the second entity. In response to the resource transfer requests, the second entity may execute one or more resource transfers (e.g., a transaction) with certain common characteristics. For example, the common characteristics may be pulled from the invoice data and may include information such as a payment amount (e.g., an exact number or within a defined margin of the exact number), a transaction date or periodicity, transaction schedule, payment platform or rail, transaction label, recipient information, and the like. The system may further pull other information with respect to invoices, such as invoice due dates. Based on the information tracked by the system, the system may anticipate incoming invoices and subsequently set up an optimized, automated transaction process.

For example, the system may detect that the first entity sends invoices to the second entity for a service offered by the first entity which is due on the first of every month. Based on this information, the system may anticipate that the second entity will receive a future invoice in the upcoming months which may be due on the first of the upcoming month. The system may further pre-populate payment terms of the invoice based on information from past invoices (e.g., payment amount, payment rail, transaction date, and the like). The system may then generate recommendations with respect to setting up future resource transfers. In some embodiments, the system may generate a prioritization scheme in which the invoices are paid by the second entity in a particular order. For instance, the system may take into account the due dates of invoices as well as the inbound/outbound flow to and from the second entity's accounts. In this regard, the system may designate certain invoices to be paid first and other invoices to be paid at a later date (e.g., when account balances are adequate to cover the invoices). In some embodiments (e.g., when invoice prices are based on daily rates), the system may automatically select the most resource-efficient day on which to pay such an invoice.

The recommendations and/or the prioritization schemes may be presented to a user (e.g., an employee or administrator of the second entity) for approval. In this regard, the system may display a graphical user interface on a user computing system which may allow the user to view the parameters of the proposed recommendations and/or prioritization schemes and interact with the elements of the user interface to submit approval (e.g., clicking a “yes” button). Once the user has approved the recommendations and/or prioritization schemes, the system may execute resource transfers (e.g., payment of invoices) automatically based on the parameters designated in the recommendations and/or prioritization schemes. In some embodiments, the system may be configured to display messages and/or notifications to the user via the graphical interface. The notifications may include alerts which contain information regarding current, potential, or future issues that may arise from the resource transfers and/or prioritization schemes. Examples of such issues may include problems with incoming/outbound funds from the second entity's accounts, withdrawal limits, account balance issues, disputed invoice amounts, and the like. In this regard, the alerts may cause the user computing system to present a pop-up notification on the display of the user computing system. The alert may comprise an audible alert portion which causes one or more output devices of the user computing system to play the audible alert.

The system as described herein confers a number of technological advantages over conventional resource transfer systems. For instance, by automating certain recurring resource transfers, the system may prevent the need for the user to manually log onto the entity's networks to executing the resource transfers, thereby reducing the computing load and resources needed to fulfill the request (e.g., processing power, networking bandwidth, memory space, I/O calls, and the like).

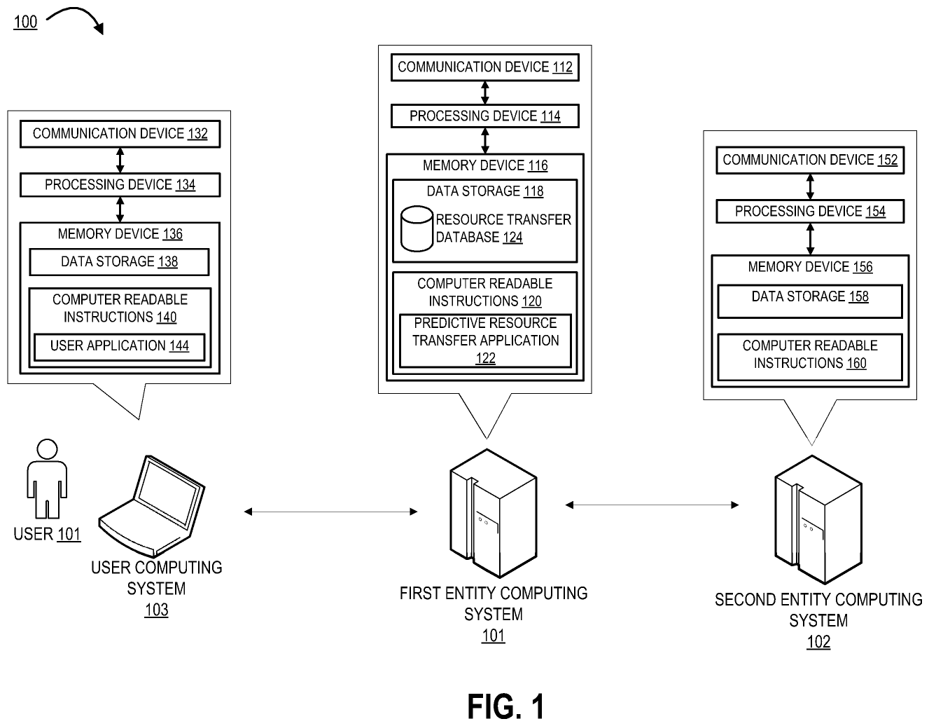

Turning now to the figures, FIG. 1 illustrates an operating environment 100 for the predictive resource transfer system, in accordance with one embodiment of the present disclosure. In particular, FIG. 1 illustrates a first entity computing system 101 that is operatively coupled, via a network, to a second entity computing system 102 and/or user computing system 103. In such a configuration, the first entity computing system 101 may, in some embodiments, transmit information to and/or receive information from the second entity computing system 102 and/or user computing system 103. It should be understood that FIG. 1 illustrates only an exemplary embodiment of the operating environment 100, and it will be appreciated that one or more functions of the systems, devices, or servers as depicted in FIG. 1 may be combined into a single system, device, or server. Furthermore, a single system, device, or server as depicted in FIG. 1 may represent multiple systems, devices, or servers. For instance, though the user first entity computing system 101 is depicted as a single unit, the operating environment 100 may comprise multiple different first entity computing systems 101 (e.g., servers, terminals, mobile devices, and the like).

The network may be a system specific distributive network receiving and distributing specific network feeds and identifying specific network associated triggers. The network include one or more cellular radio towers, antennae, cell sites, base stations, telephone networks, cloud networks, radio access networks (RAN), WiFi networks, or the like. Additionally, the network may also include a global area network (GAN), such as the Internet, a wide area network (WAN), a local area network (LAN), or any other type of network or combination of networks. Accordingly, the network may provide for wireline, wireless, or a combination wireline and wireless communication between devices on the network.

As illustrated in FIG. 1, the first entity computing system 101 may be a computing system owned and/or operated by a first entity that performs the resource transfer analysis functions as described herein. Accordingly, the first entity may be an organization such as a business who may have an established relationship with a second entity (e.g., the first entity purchases goods and/or services from the second entity). The first entity computing system 101 may comprise a communication device 112, a processing device 114, and a memory device 116. The first entity computing system 101 may be a device such as a networked server, desktop computer, terminal, or any other type of computing system as described herein. As used herein, the term “processing device” generally includes circuitry used for implementing the communication and/or logic functions of the particular system. For example, a processing device may include a digital signal processor device, a microprocessor device, and various analog-to-digital converters, digital-to-analog converters, and other support circuits and/or combinations of the foregoing. Control and signal processing functions of the system are allocated between these processing devices according to their respective capabilities. The processing device may include functionality to operate one or more software programs based on computer-readable instructions thereof, which may be stored in a memory device.

The processing device 114 is operatively coupled to the communication device 112 and the memory device 116. The processing device 114 uses the communication device 112 to communicate with the network and other devices on the network, such as, but not limited to the second entity computing system 102 and/or user computing system 103. The communication device 112 generally comprises a modem, antennae, WiFi or Ethernet adapter, radio transceiver, or other device for communicating with other devices on the network.

The memory device 116 may have computer-readable instructions 120 stored thereon, which in one embodiment includes the computer-readable instructions 120 of a predictive resource transfer application 122 which executes the recurring resource transfer prediction and analysis functions as described herein. In some embodiments, the memory device 116 includes data storage 118 for storing data related to the system environment. In this regard, the data storage 118 may comprise a resource transfer database 124, which may include various types of data, metadata, executable code, or other types of information regarding the resources transfers executed and/or received by the first entity, such as invoice data, account information, historical resource transfer data, and the like.

As further illustrated in FIG. 1, the operating environment 100 may further comprise a user computing system 103 in operative communication with the first entity computing system 101. The user computing system 103 may be a computing system that is operated by a user 101, such as an employee or administrator of the first entity. Accordingly, the user computing system 103 may be a device such as a desktop computer, laptop, IoT device, smartphone, tablet, single-board computer, or the like. The user computing system 103 may further comprise a user interface comprising one or more input devices (e.g., a keyboard, keypad, microphone, mouse, tracking device, biometric readers, capacitive sensors, or the like) and/or output devices (e.g., a display such as a monitor, projector, headset, touchscreen, and/or auditory output devices such as speakers, headphones, or the like).

The user computing system 103 may further comprise a processing device 134 operatively coupled to a communication device 132 and a memory device 136 having data storage 138 and computer readable instructions 140 stored thereon. The computer readable instructions 140 may comprise a user application 144 which may receive inputs from the user 101 and produce outputs to the user 101. In particular, the user application 144 may comprise various applications which allow the user 101 to interact with the first entity computing system 101 (e.g., receiving notifications and/or recommendations, approving recommendations and/or prioritization schemes, scheduling recurring resource transfers, or the like).

The communication devices as described herein may comprise a wireless local area network (WLAN) such as WiFi based on the Institute of Electrical and Electronics Engineers' (IEEE) 802.11 standards, Bluetooth short-wavelength UHF radio waves in the ISM band from 2.4 to 2.485 GHz or other wireless access technology. Alternatively or in addition to the wireless interface, the computing systems may also include a communication interface device that may be connected by a hardwire connection to the resource distribution device. The interface device may comprise a connector such as a USB, SATA, PATA, SAS or other data connector for transmitting data to and from the respective computing system.

In some embodiments, the operating environment 100 may further comprise a second entity computing system 102 owned and/or operated by a second entity. The second entity may be an organization which has an established relationship with the first entity (e.g., the second entity provides good and/or services to the first entity). The second entity computing system 102 may comprise a processing device 154 communicatively coupled to a communication device 152 and a memory device 156 comprising data storage 158 and computer readable instructions 160. The second entity computing system 102 may transmit resource transfer requests (e.g., invoices) to the first entity computing system 101 over the network.

The computing systems described herein may each further include a processing device communicably coupled to devices as a memory device, output devices, input devices, a network interface, a power source, a clock or other timer, a camera, a positioning system device, a gyroscopic device, one or more chips, and the like.

In some embodiments, the computing systems may access one or more databases or datastores (not shown) to search for and/or retrieve information related to the service provided by the entity. The computing systems may also access a memory and/or datastore local to the various computing systems within the operating environment 100.

The processing devices as described herein may include functionality to operate one or more software programs or applications, which may be stored in the memory device. For example, a processing device may be capable of operating a connectivity program, such as a web browser application. In this way, the computing systems may transmit and receive web content, such as, for example, product valuation, service agreements, location-based content, and/or other web page content, according to a Wireless Application Protocol (WAP), Hypertext Transfer Protocol (HTTP), and/or the like.

A processing device may also be capable of operating applications. The applications may be downloaded from a server and stored in the memory device of the computing systems. Alternatively, the applications may be pre-installed and stored in a memory in a chip.

The chip may include the necessary circuitry to provide integration within the devices depicted herein. Generally, the chip will include data storage which may include data associated with the service that the computing systems may be communicably associated therewith. The chip and/or data storage may be an integrated circuit, a microprocessor, a system-on-a-chip, a microcontroller, or the like. In this way, the chip may include data storage. Of note, it will be apparent to those skilled in the art that the chip functionality may be incorporated within other elements in the devices. For instance, the functionality of the chip may be incorporated within the memory device and/or the processing device. In a particular embodiment, the functionality of the chip is incorporated in an element within the devices. Still further, the chip functionality may be included in a removable storage device such as an SD card or the like.

A processing device may be configured to use the network interface to communicate with one or more other devices on a network. In this regard, the network interface may include an antenna operatively coupled to a transmitter and a receiver (together a “transceiver”). The processing device may be configured to provide signals to and receive signals from the transmitter and receiver, respectively. The signals may include signaling information in accordance with the air interface standard of the applicable cellular system of the wireless telephone network that may be part of the network. In this regard, the computing systems may be configured to operate with one or more air interface standards, communication protocols, modulation types, and access types. By way of illustration, the devices may be configured to operate in accordance with any of a number of first, second, third, fourth, and/or fifth-generation communication protocols and/or the like. For example, the computing systems may be configured to operate in accordance with second-generation (2G) wireless communication protocols IS-136 (time division multiple access (TDMA)), GSM (global system for mobile communication), and/or IS-95 (code division multiple access (CDMA)), or with third-generation (3G) wireless communication protocols, such as Universal Mobile Telecommunications System (UMTS), CDMA2000, wideband CDMA (WCDMA) and/or time division-synchronous CDMA (TD-SCDMA), with fourth-generation (4G) wireless communication protocols, with fifth-generation (5G) wireless communication protocols, or the like. The devices may also be configured to operate in accordance with non-cellular communication mechanisms, such as via a wireless local area network (WLAN) or other communication/data networks.

The network interface may also include an application interface in order to allow a user or service provider to execute some or all of the above-described processes. The application interface may have access to the hardware, e.g., the transceiver, and software previously described with respect to the network interface. Furthermore, the application interface may have the ability to connect to and communicate with an external data storage on a separate system within the network.

The devices may have an interface that includes user output devices and/or input devices. The output devices may include a display (e.g., a liquid crystal display (LCD) or the like) and a speaker or other audio device, which are operatively coupled to the processing device. The input devices, which may allow the devices to receive data from a user, may include any of a number of devices allowing the devices to receive data from a user, such as a keypad, keyboard, touch-screen, touchpad, microphone, mouse, joystick, other pointer device, button, soft key, and/or other input device(s).

The devices may further include a power source. Generally, the power source is a device that supplies electrical energy to an electrical load. In some embodiment, power source may convert a form of energy such as solar energy, chemical energy, mechanical energy, or the like to electrical energy. Generally, the power source may be a battery, such as a lithium battery, a nickel-metal hydride battery, or the like, that is used for powering various circuits, e.g., the transceiver circuit, and other devices that are used to operate the devices. Alternatively, the power source may be a power adapter that can connect a power supply from a power outlet to the devices. In such embodiments, a power adapter may be classified as a power source “in” the devices.

As described above, the computing devices as shown in FIG. 1 may also include a memory device operatively coupled to the processing device. As used herein, “memory” may include any computer readable medium configured to store data, code, or other information. The memory device may include volatile memory, such as volatile Random Access Memory (RAM) including a cache area for the temporary storage of data. The memory device may also include non-volatile memory, which can be embedded and/or may be removable. The non-volatile memory may additionally or alternatively include an electrically erasable programmable read-only memory (EEPROM), flash memory or the like.

The memory device may store any of a number of applications or programs which comprise computer-executable instructions/code executed by the processing device to implement the functions of the devices described herein.

The computing systems may further comprise a gyroscopic device. The positioning system, input device, and the gyroscopic device may be used in correlation to identify phases within a service term.

Each computing system may also have a control system for controlling the physical operation of the device. The control system may comprise one or more sensors for detecting operating conditions of the various mechanical and electrical systems that comprise the computing systems or of the environment in which the computing systems are used. The sensors may communicate with the processing device to provide feedback to the operating systems of the device. The control system may also comprise metering devices for measuring performance characteristics of the computing systems. The control system may also comprise controllers such as programmable logic controllers (PLC), proportional integral derivative controllers (PID) or other machine controllers. The computing systems may also comprise various electrical, mechanical, hydraulic or other systems that perform various functions of the computing systems. These systems may comprise, for example, electrical circuits, motors, compressors, or any system that enables functioning of the computing systems.

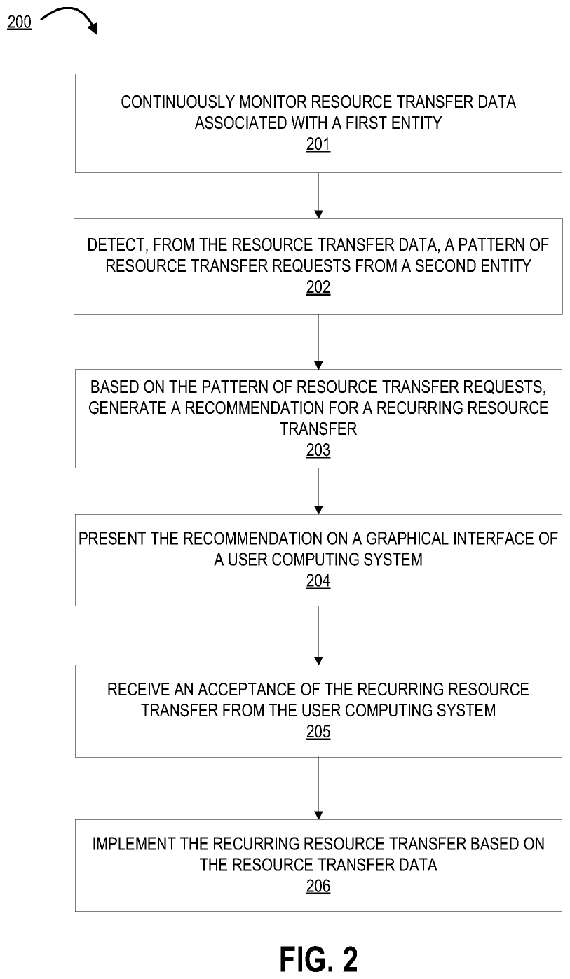

FIG. 2 illustrates a process flow 200 for the predictive resource transfer system, in accordance with some embodiments of the present disclosure. The process begins at block 201, where the system continuously monitors resource transfer data associated with a first entity. The first entity may be, for instance, a business organization which receives resource transfer requests (e.g., invoices) for goods or services rendered. In this regard, the system, which may be owned and/or operated by an entity such as a financial institution, may monitor resource and resource transfer data associated with the first entity. In this regard, the system may monitor data regarding incoming invoices (e.g., due dates, invoice receipt dates, payment terms, periodicity, and the like) as well as account information, flow of resources in and out of the accounts, payment methods or processes used, and the like.

The process continues to block 202, where the system detects, from the resource transfer data, a pattern of resource transfer requests from a second entity. For example, the system may detect that the second entity, which may be an organization with a business relationship with the first entity (e.g., the second entity is a supplier of the first entity) and sends invoices to the first entity. The system may track data associated with the invoices, such as the timeframes and/or frequency with which the invoices are sent, as well as the contents of the invoices themselves (e.g., payment terms, amounts, payment schedules, and the like). Based on the tracked data, the system may predict that the second entity will send another invoice at a predicted time in the future. For instance, if the second entity sends bi-weekly invoices on certain days according to the historical data, the system may predict that the second entity will send a future invoice based on the established timeframe and frequency.

The process continues to block 203, where the system, based on the pattern of resource transfer requests, generates a recommendation for a recurring resource transfer. Continuing the above example, the recommendation may be to set up a recurring payment for the invoices received from the second entity on a bi-weekly basis. The recommendation may further automatically incorporate payment terms for the invoice. For instance, the recurring payment may include automatically populated terms such as payment amount, transfer date, due date, and the like.

The process continues to block 204, where the system presents the recommendation on a graphical interface of a user computing system. The user, who may be an employee or administrator of the first entity, may be able to view the proposed terms of the future resource transfer as detailed in the recommendation. For example, the recommendation may be displayed as a prompt or query to the user to accept or reject the recommendation to set up one or more future resource transfers based on the invoice terms detected from historical data. Continuing the above example, the system may provide a recommendation to the user to set up recurring payments from an account of the first entity to an account of the second entity on a bi-weekly basis in response to the bi-weekly invoices sent by the second entity. The details of the recurring payment may include the payment amount, payment rail, transfer date, and the like, which may be determined based on historical invoice data.

The process continues to block 205, where the system receives an acceptance of the recurring resource transfer from the user computing system. As described above, the user may be able to view the details of the recommendation on the graphical user interface presented on the display of the user computing system. The user interface may further comprise an interactive interface element (e.g., clickable or touchable button) which may allow the user to accept or reject the recommendation.

The process concludes at block 206, where the system implements the recurring resource transfer based on the resource transfer data. In particular, the system may implement the recurring resource transfer according to the details extracted from the historical data. In some embodiments, the recurring resource transfer may be set up to occur a certain number of times (e.g., twice). In other embodiments, the recurring resource transfer may be executed on a periodic, indefinite basis until halted by the user and/or the first entity.

In some embodiments, the system may generate a prioritization scheme to manage the recurring resource transfers. For instance, the system may track the due dates of the invoices for which recurring resource transfers have been implemented. The system may further track the flow of funds in and out of the first entity's account. Based on the above information, the system may decide which resource transfers are to be resolved first and which may be resolved later.

The system may further be configured to transmit notifications and/or alerts to the user based on predictive analysis. For instance, the system may detect that an account balance may not meet the threshold requirement for executing a scheduled resource transfer (e.g., based on current account balance and/or flow of funds into and out of the account). The system may further take into account limitations that may be imposed by the entity issuing the account. For example, the entity may enforce withdrawal/transfer limits for the account. The system may track the limits and the number of transfers involving the account and subsequently reconfigure the prioritization scheme to prevent exceeding the transfer limits.

Each communication interface described herein generally includes hardware, and, in some instances, software, that enables the computer system, to transport, send, receive, and/or otherwise communicate information to and/or from the communication interface of one or more other systems on the network. For example, the communication interface of the user input system may include a wireless transceiver, modem, server, electrical connection, and/or other electronic device that operatively connects the user input system to another system. The wireless transceiver may include a radio circuit to enable wireless transmission and reception of information.

As will be appreciated by one of ordinary skill in the art, the present invention may be embodied as an apparatus (including, for example, a system, a machine, a device, a computer program product, and/or the like), as a method (including, for example, a business process, a computer-implemented process, and/or the like), or as any combination of the foregoing. Accordingly, embodiments of the present invention may take the form of an entirely software embodiment (including firmware, resident software, micro-code, and the like), an entirely hardware embodiment, or an embodiment combining software and hardware aspects that may generally be referred to herein as a “system.” Furthermore, embodiments of the present invention may take the form of a computer program product that includes a computer-readable storage medium having computer-executable program code portions stored therein.

As the phrase is used herein, a processor may be “configured to” perform a certain function in a variety of ways, including, for example, by having one or more general-purpose circuits perform the function by executing particular computer-executable program code embodied in computer-readable medium, and/or by having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, infrared, electromagnetic, and/or semiconductor system, apparatus, and/or device. For example, in some embodiments, the non-transitory computer-readable medium includes a tangible medium such as a portable computer diskette, a hard disk, a random access memory (RAM), a read-only memory (ROM), an erasable programmable read-only memory (EEPROM or Flash memory), a compact disc read-only memory (CD-ROM), and/or some other tangible optical and/or magnetic storage device. In other embodiments of the present invention, however, the computer-readable medium may be transitory, such as a propagation signal including computer-executable program code portions embodied therein.

It will also be understood that one or more computer-executable program code portions for carrying out the specialized operations of the present invention may be required on the specialized computer include object-oriented, scripted, and/or unscripted programming languages, such as, for example, Java, Perl, Smalltalk, C++, SAS, SQL, Python, Objective C, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

Embodiments of the present invention are described above with reference to flowcharts and/or block diagrams. It will be understood that steps of the processes described herein may be performed in orders different than those illustrated in the flowcharts. In other words, the processes represented by the blocks of a flowchart may, in some embodiments, be in performed in an order other that the order illustrated, may be combined or divided, or may be performed simultaneously. It will also be understood that the blocks of the block diagrams illustrated, in some embodiments, merely conceptual delineations between systems and one or more of the systems illustrated by a block in the block diagrams may be combined or share hardware and/or software with another one or more of the systems illustrated by a block in the block diagrams. Likewise, a device, system, apparatus, and/or the like may be made up of one or more devices, systems, apparatuses, and/or the like. For example, where a processor is illustrated or described herein, the processor may be made up of a plurality of microprocessors or other processing devices which may or may not be coupled to one another. Likewise, where a memory is illustrated or described herein, the memory may be made up of a plurality of memory devices which may or may not be coupled to one another.

It will also be understood that the one or more computer-executable program code portions may be stored in a transitory or non-transitory computer-readable medium (e.g., a memory, and the like) that can direct a computer and/or other programmable data processing apparatus to function in a particular manner, such that the computer-executable program code portions stored in the computer-readable medium produce an article of manufacture, including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with operator and/or human-implemented steps in order to carry out an embodiment of the present invention.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. A system for automated resource transfers based on predictive electronic data analysis, the system comprising:
a memory device with computer-readable program code stored thereon;
a communication device; and
a processing device operatively coupled to the memory device and the communication device, wherein the processing device is configured to execute the computer-readable program code to:
continuously monitor resource transfer data associated with a first entity;
detect, from the resource transfer data, a pattern of resource transfer requests from a second entity to the first entity;
based on the pattern of resource transfer requests, generate a recommendation for a recurring resource transfer from the first entity to the second entity;
present the recommendation on a graphical interface of a user computing system;
receive an acceptance of the recurring resource transfer from the user computing system; and
implement the recurring resource transfer based on the resource transfer data.

2. The system according to claim 1, wherein implementing the recurring resource transfer comprises:
detecting one or more resource transfer parameters from the resource transfer data; and
scheduling an automatic recurring resource transfer based on the resource transfer parameters.

3. The system according to claim 2, wherein the resource transfer parameters comprises at least one of a resource transfer amount, a resource transfer date, and a resource transfer frequency.

4. The system according to claim 1, wherein the recurring resource transfer is executed a predetermined number of times.

5. The system according to claim 1, wherein the recurring resource transfer is executed indefinitely at a predetermined frequency.

6. The system according to claim 1, wherein the computer-readable program code further causes the processing device to generate a prioritization scheme for one or more recurring resource transfers.

7. The system according to claim 6, wherein the computer-readable program code further causes the processing device to transmit an alert to the user computing system, wherein the alert comprises information regarding a resource transfer issue.

8. A computer program product for automated resource transfers based on predictive electronic data analysis, the computer program product comprising at least one non-transitory computer readable medium having computer-readable program code portions embodied therein, the computer-readable program code portions comprising executable code portions for:
continuously monitoring resource transfer data associated with a first entity;
detecting, from the resource transfer data, a pattern of resource transfer requests from a second entity to the first entity;
based on the pattern of resource transfer requests, generating a recommendation for a recurring resource transfer from the first entity to the second entity;
presenting the recommendation on a graphical interface of a user computing system;
receiving an acceptance of the recurring resource transfer from the user computing system; and
implementing the recurring resource transfer based on the resource transfer data.

9. The computer program product according to claim 8, wherein implementing the recurring resource transfer comprises:
detecting one or more resource transfer parameters from the resource transfer data; and
scheduling an automatic recurring resource transfer based on the resource transfer parameters.

10. The computer program product according to claim 9, wherein the resource transfer parameters comprises at least one of a resource transfer amount, a resource transfer date, and a resource transfer frequency.

11. The computer program product according to claim 8, wherein the recurring resource transfer is executed a predetermined number of times.

12. The computer program product according to claim 8, wherein the recurring resource transfer is executed indefinitely at a predetermined frequency.

13. The computer program product according to claim 8, wherein the computer-readable program code portions further comprise executable portions for generating a prioritization scheme for one or more recurring resource transfers.

14. A computer-implemented method for automated resource transfers based on predictive electronic data analysis, wherein the method comprises:
continuously monitoring resource transfer data associated with a first entity;
detecting, from the resource transfer data, a pattern of resource transfer requests from a second entity to the first entity;
based on the pattern of resource transfer requests, generating a recommendation for a recurring resource transfer from the first entity to the second entity;
presenting the recommendation on a graphical interface of a user computing system;
receiving an acceptance of the recurring resource transfer from the user computing system; and
implementing the recurring resource transfer based on the resource transfer data.

15. The computer-implemented method according to claim 14, wherein implementing the recurring resource transfer comprises:
detecting one or more resource transfer parameters from the resource transfer data; and
scheduling an automatic recurring resource transfer based on the resource transfer parameters.

16. The computer-implemented method according to claim 15, wherein the resource transfer parameters comprises at least one of a resource transfer amount, a resource transfer date, and a resource transfer frequency.

17. The computer-implemented method according to claim 14, wherein the recurring resource transfer is executed a predetermined number of times.

18. The computer-implemented method according to claim 14, wherein the recurring resource transfer is executed indefinitely at a predetermined frequency.

19. The computer-implemented method according to claim 14, wherein the method further comprises generating a prioritization scheme for one or more recurring resource transfers.

20. The computer-implemented method according to claim 19, wherein the method further comprises transmitting an alert to the user computing system, wherein the alert comprises information regarding a resource transfer issue.
